(19) United States
(12) Patent Application Publication
(10) Pub. No.: US 2008/0303922 A1
(43) Pub. Date: Dec. 11, 2008

(54) Image capture

(76) Inventors: Imran Chaudhri, San Francisco, CA (US); Kenneth C. Dyke, Sunnyvale, CA (US)

Correspondence Address: James C. Scheller;BLAKELY, SOKOLOFF, TAYLOR & ZAFMAN LLP, 1279 Oakmead Parkway, Sunnyvale, CA, 94085-4040, US

(21) Appl. No.: 11/811,100

(22) Filed: Jun. 8, 2007

(51) Int. Cl. H04N 5/76; H04N 5/228; H04N 5/235

(52) U.S. Cl. 348/231.99; 348/222.1; 348/362; 348/E05.034; 348/E05.031

(57) ABSTRACT

Embodiments of methods and apparatuses to improve image capturing are described. In certain embodiments, an apparatus to improve image capturing includes a camera, a processor coupled to the camera, and one or more ambient light sensors coupled to the processor. The one or more ambient light sensors may be located outside the camera. The processor may be configured to obtain first light data using the ambient light sensor, and to determine an image type based on at least the first light data. The processor may be further configured to adjust one or more camera parameters based on the image type. In one embodiment, the apparatus to improve image capturing includes a cell phone coupled to the processor. In one embodiment, the apparatus to improve image capturing is a portable handheld device.

### COPYRIGHT NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright ©2007, Apple Inc., All Rights Reserved.

### FIELD OF THE INVENTION

Embodiments of the invention relate to image capturing, and more particularly, to systems and methods to provide improved image capturing.

### BACKGROUND

Electronic portable and non-portable devices, such as computers and cell phones, are becoming increasingly common. Such electronic devices have grown more complex over time, incorporating many features including, for example, MP3 player capabilities, web browsing capabilities, capabilities of personal digital assistants (PDAs), and the like. Electronic portable and non-portable devices, such as computers and cell phones, may feature a camera to capture images (movies or videos), and a photo management application to manage images.

Cameras may work with the light of the visible spectrum or with other portions of the electromagnetic spectrum. A camera generally has an enclosed hollow, with an opening (aperture) at one end for light to enter, and a recording or viewing surface for capturing the light at the other end. A typical camera has a lens positioned in front of the camera's opening to gather the incoming light and to focus the image, on the recording surface. The diameter of the aperture may be controlled by a diaphragm mechanism.

FIG. 1 shows a schematic diagram of the optical components of a typical single-lens reflex (“SLR”) camera 100. As shown in FIG. 1, the light 109 that passes through a lens assembly 101 of the SLR camera 100 is reflected by mirror 102, and is projected on a focusing screen 105. Via a condensing lens 106 and internal reflections in a roof pentaprism 107, the image appears in an eyepiece 108. When an image is captured, mirror 102 moves in the direction 110, the focal shutter 103 opens, and the image is projected onto a film or image sensor 104 as on focusing screen 105.

FIG. 2 shows a block diagram of a typical digital camera 200 that uses electronics to capture the images. As shown in FIG. 2, light 203 from an object (not shown) passes through an optics 202 to an image sensor 201. Image sensor 201 may be a charge coupled device (“CCD”) or a complementary metal oxide semiconductor (“CMOS”) sensor to capture images. As shown in FIG. 2, image sensor 202 is coupled to a processor 204. The images captured by image sensor 201 can be transferred and stored in a memory of a processor 204 for later playback or processing. Some of the cameras may use an infrared (“IR”) sensor (not shown) to help camera optics 202 in focusing to the object.

Before capturing of the image, the settings of the camera 200, such as an exposure time, an exposure level, shutter speed, may be set by a user. For example, to take the picture outside a room, the user may set the exposure level and shutter speed of the camera to an “outdoors” profile; and for taking the picture inside the room, the user may set the exposure level and shutter speed of the camera to an “indoors” profile. The pre-determined profile “outdoors” may correspond to sunlight illumination, and the pre-determined profile “indoors” may correspond to artificial light illumination. The pre-determined profiles of the camera, however, may not accurately satisfy real lighting conditions that occur while the picture is taken. Therefore, the quality of the captured image may not be good enough and may not correspond to real lighting conditions.

After the image has been captured, processor 204 may process the image to adjust, for example, a color of the image. Processor 204 typically adjusts the color of the captured image using the pixel information provided by image sensor 201. Processor 204, however, does not have any information about real lighting conditions at the time of image capturing. The lack of the information about real lighting conditions during the image capturing may negatively impact the quality of the captured image.

### SUMMARY OF THE DESCRIPTION

Embodiments of methods and apparatuses to capture an image are described. In certain embodiments, an apparatus to capture an image includes a camera, a processor coupled to the camera, and an ambient light sensor (ALS) coupled to the processor. The ALS may be located outside the camera. The processor may be configured to obtain first light data using the ambient light sensor, and to automatically determine an image type based on at least the first light data. The processor may be further configured to adjust one or more camera parameters based on the image type. In one embodiment, the camera has an image sensor, and the processor is further configured to receive second light data from the image sensor. In one embodiment, the apparatus to capture an image includes a cell phone coupled to the processor. In one embodiment, the apparatus to capture an image is a portable handheld device.

In one embodiment, a device to capture an image includes a camera having an image sensor. A processor may be coupled to the camera. One or more ambient light sensors (ALSs) may be coupled to the processor. The processor may be configured to receive second data from the image sensor; receive first data from the one or more ALSs; and to determine an image type using the first data and the second data. The one or more ALSs may be located outside the camera. The processor may be further configured to adjust one or more camera parameters based on the image type.

In one embodiment, a device to capture an image includes a camera, a processor coupled to the camera, one or more ambient light (ALS) sensors, a display, and a memory that are coupled to the processor. The processor may be configured to receive first ambient light data from the one or more ambient light sensors, to determine a first image type based on at least the first ambient light data, to adjust one or more camera parameters based on the first image type to provide a first camera setting. The processor further may be configured to capture a first image using the first camera setting, to present the first image to a user on the display, to receive a user selection of the first image; and to store the first camera setting associated with the selected first image in a memory in response to the user selection.

In one embodiment, first light data are obtained using an ambient light sensor. The first light data may be obtained, for example, by measuring an ambient light intensity. An image type may be determined based on at least the first light data. The ambient light sensor may be located outside a camera. Further, one or more camera parameters may be adjusted based on the image type. Determining the image type may include determining lighting conditions to capture the image. In one embodiment, second light data associated with an object may be obtained using an image sensor.

In one embodiment, first data from one or more ambient light (ALS) sensors and second data from an image sensor are received. The first data may be associated with an environment outside the object and the second data may be associated with an object. For example, the first data may include an ambient light intensity that surrounds the object. The second data may be associated, for example, with illuminating of an object. An image type may be determined using the first data and the second data. Further, one or more camera parameters may be adjusted based on the image type. The one or more camera parameters may be, for example, an exposure time, an exposure level, a shutter speed, a focal length, a white balance, a color profile, or any combination thereof.

In one embodiment, first ambient light data from one or more ambient light sensors are received. A first image type may be determined based on the first ambient light data. One or more camera parameters may be adjusted based on the first image type, to provide a first camera setting. A first image of an object may be captured using the first camera setting.

The first image may be presented to a user. Next, a user selection of the first image may be received. The first camera setting associated with the selected first image may be stored in a memory in response to the user selection. In one embodiment, second ambient light data from the one or more ALS sensors are received. A second image type may be determined based on the second ambient light data. Next, a determination may be made whether the second image type matches the first image type. A second image may be captured using the first camera setting stored in the memory if the second image type matches the first image type. The one or more camera parameters may be adjusted based on the second image type, to provide a second camera setting if the second image type does not match the first image type. A third image may be captured using the second camera setting. The one or more camera parameters may be an exposure time, an exposure level, a shutter speed, a focal length, a white balance, a color profile, or any combination thereof.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 shows a schematic diagram of the optical components of a typical single-lens reflex camera.

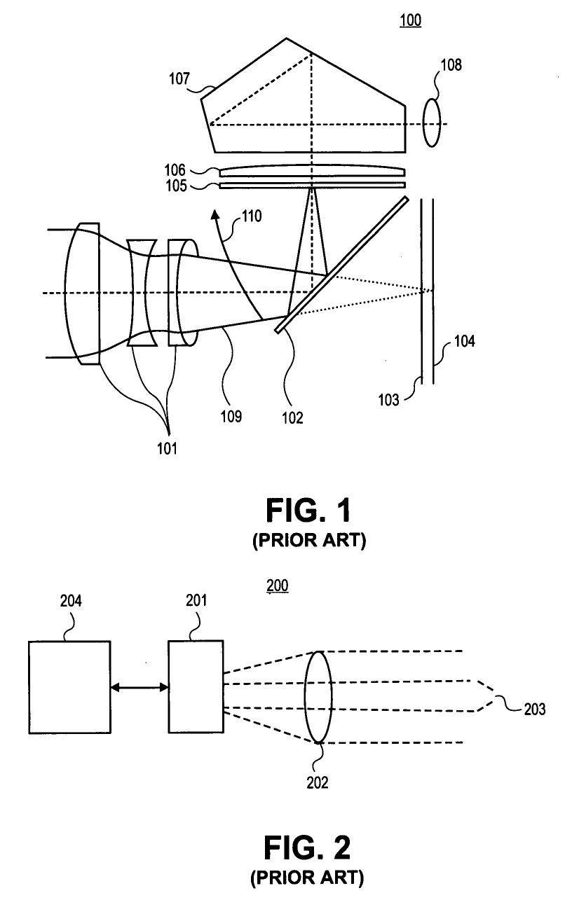

FIG. 2 shows a block diagram of a typical digital camera that uses electronics to capture images.

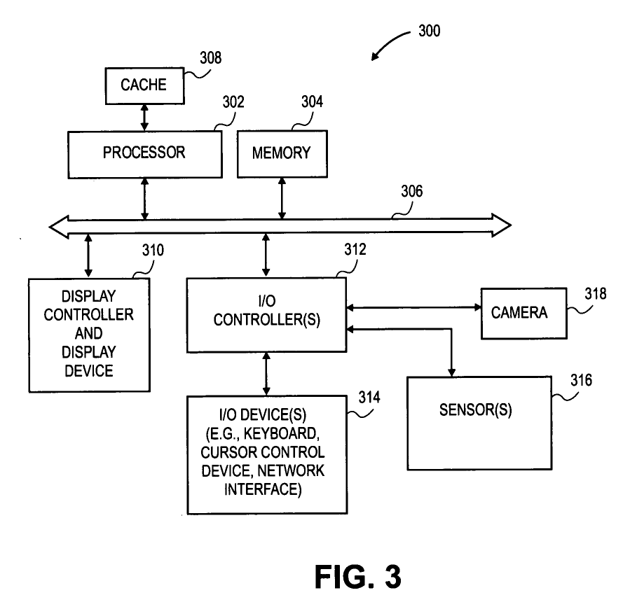

FIG. 3 shows an example of a device that may be used in at least one embodiment of the present invention.

FIG. 4 shows an embodiment of a device which includes the capability for wireless communication.

FIG. 5 shows a block-diagram of one embodiment a device to capture an image.

FIG. 6A illustrates a portable device to capture an image according to one embodiment of the invention.

FIG. 6B shows a side view of one embodiment of a portable device to capture an image.

FIGS. 7A, 7B, and 7C illustrate a portable device according to another embodiment of the invention.

FIG. 8 is a flowchart of one embodiment of a method to capture an image.

FIG. 9 is a flowchart of one embodiment of a method to improve image capturing.

FIGS. 10A and 10B show a flowchart of one embodiment of a method to capture an improved image using a camera.

FIGS. 11A-11B illustrate a front view and a back view of a portable device to capture an improved image according to one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk, including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of media.

The algorithms and displays presented herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, Calif., a touch screen input device, pushbutton device, movable pointing input device or other input device. The media selection device may be used to select the media stored on the storage device and/or the remote storage device. The portable media player may, in one embodiment, include a display device which is coupled to the media processing system to display titles or other indicators of media being selected through the input device and being presented, either through a speaker or earphone(s), or on the display device, or on both display device and a speaker or earphone(s).

Embodiments of the inventions described herein may be part of other types of data processing systems, such as, for example, entertainment systems or personal digital assistants (PDAs), or general purpose computer systems, or special purpose computer systems, or an embedded device within another device, or cellular telephones which do not include media players, or devices which combine aspects or functions of these devices (e.g., a media player, such as an iPod®, combined with a PDA, an entertainment system, and a cellular telephone in one portable device), or devices or consumer electronic products which include a multi-touch input device such as a multi-touch handheld device or a cell phone with a multi-touch input device.

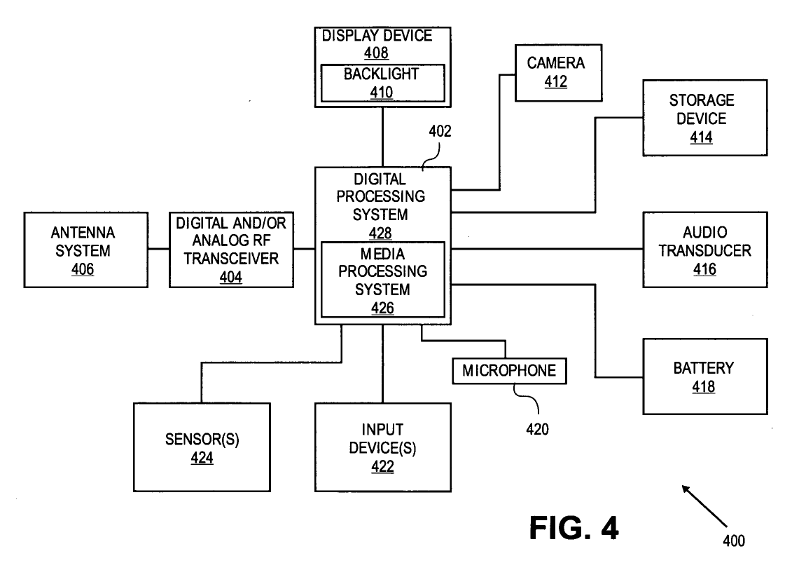

FIG. 3 shows an example of a device that may be used in at least one embodiment of the present invention. Device 300 may include a processor 302 (e.g., a microprocessor), and a memory 304 (e.g., a storage device), which are coupled to each other through a bus 306. The device 300 may optionally include a cache 308 which is coupled to the processor 302. This device may also optionally include a display controller and display device 310 which is coupled to the other components through the bus 306. One or more input/output controllers 312 are also coupled to bus 306 to provide an interface for input/output devices 314 (e.g., user interface controls or input devices), to provide an interface for one or more sensors 316, and to provide an interface for a camera 318. One or more sensors 316 may include, for example, one or more ambient light sensors (“ALS”), a proximity sensor, and any combination thereof. According to at least some embodiments, the output of the one or more sensors 316 may be a value or level of ambient light (e.g., visible ambient light) sent by the sensor and received by a device, processor, or software application. For example, the ambient light sensor “value” may be an ALS level, or output, such as a reading, electrical signal level or amplitude output by an ALS based on a level or intensity of ambient light received by or incident upon the ALS. The output of the one or more sensors 316 can be used to capture an improved image with camera 318, as described in further detail below. The bus 306 may include one or more buses connected to each other through various bridges, controllers, and/or adapters as is well known in the art. The input/output devices 314 may include a keypad or keyboard or a cursor control device such as a touch input panel. Furthermore, the input/output devices 314 may include a network interface which is either for a wired network or a wireless network (e.g. an RF transceiver). In at least certain embodiments, processor 302 may receive data from one or more sensors 316 and may perform the analysis of that data to capture an image as described below. For example, the data may be analyzed through an artificial intelligence process or in the other ways described herein. As a result of that analysis, the processor 302 may then (automatically in some cases) cause an adjustment in one or more settings of the device. The term “automatically” may describe a cause and effect relationship, such as where something is altered, changed, or set without receiving a user input or action directed at the altered or changed result. In some cases, the term “automatically” may describe a result that is a secondary result or in addition to a primary result according to a received user setting or selection. Device 300 may be a laptop or otherwise portable computer, such as a handheld general purpose computer or a cellular telephone, or a desktop computer.

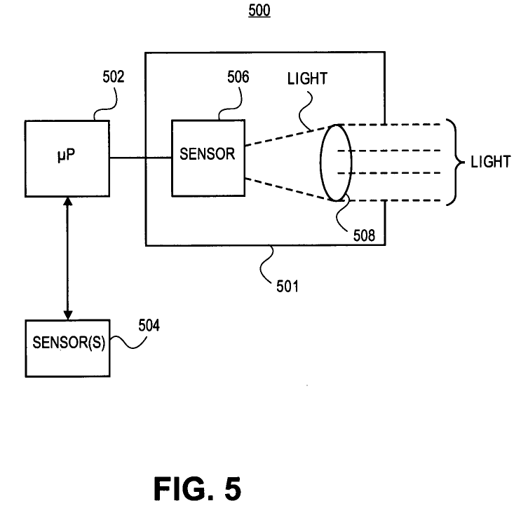

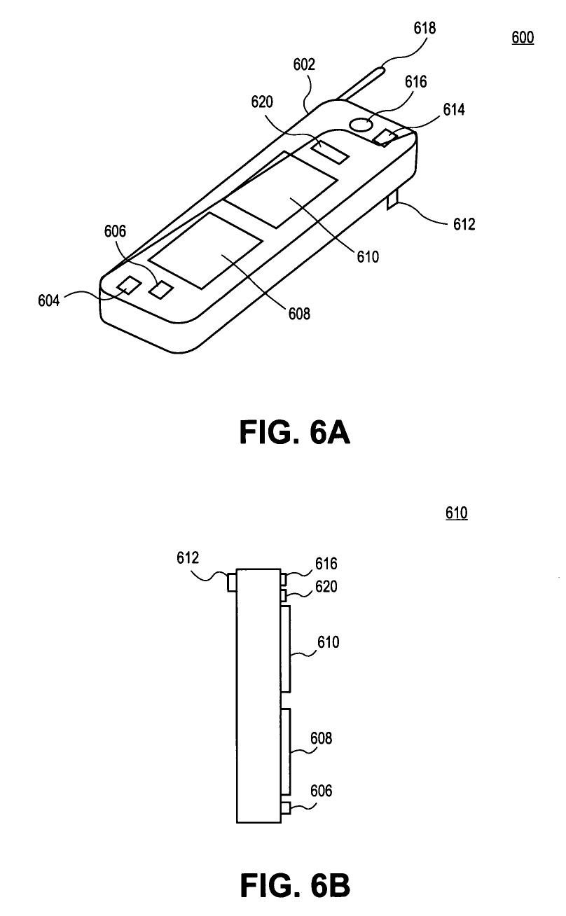

FIG. 4 shows an embodiment of a wireless device 400 which includes the capability for wireless communication. The wireless device 400 may be included in any one of the devices shown in FIGS. 5, 6A-6B, and 7A-7C, although alternative embodiments of those devices of FIGS. 5, 6A-6B, and 7A-7C may include more or fewer components than the wireless device 400.

Wireless device 400 may include an antenna system 406. Wireless device 400 may also include one or more digital and/or analog radio frequency (RF) transceivers 404, coupled to the antenna system 406, to transmit and/or receive voice, digital data and/or media signals through antenna system 406. Transceivers 404, may include on or more infrared (IR) transceivers, WiFi transceivers, Blue Tooth™ transceivers, and/or wireless cellular transceivers,

Wireless device 400 may also include a digital processing device or system 402 to control the digital RF transceivers and to manage the voice, digital data and/or media signals. Digital processing system 402 may be a general purpose processing device, such as a microprocessor or controller for example. Digital processing system 402 may also be a special purpose processing device, such as an ASIC (application specific integrated circuit), FPGA (field-programmable gate array) or DSP (digital signal processor). Digital processing system 402 may also include other devices, as are known in the art, to interface with other components of wireless device 400. For example, digital processing system 402 may include analog-to-digital and digital-to-analog converters to interface with other components of wireless device 400. Digital processing system 402 may include a media processing system 426, which may also include a general purpose or special purpose processing device to manage media, such as files of audio data.

Wireless device 400 may also include a storage device 414 (e.g., memory), coupled to the digital processing system, to store data and/or operating programs for the wireless device 400. Storage device 414 may be, for example, any type of solid-state or magnetic memory device.

Wireless device 400 may also include one or more input devices 422 (e.g., user interface controls, or 1/O devices), coupled to the digital processing system 402, to accept user inputs (e.g., telephone numbers, names, addresses, media selections, user settings, user selected brightness levels, etc.) Input device 422 may be, for example, one or more of a keypad, a touchpad, a touch screen, a pointing device in combination with a display device or similar input device. As shown in FIG. 4, digital processing system 402 is coupled to an input device 412, such as a camera, to capture one or more images, as described in further detail below.

Wireless device 400 may also include at least one display device 408, coupled to the digital processing system 402, to display text, images, and/or video. Device 408 may display information such as messages, telephone call information, user settings, user selected brightness levels, contact information, pictures, movies and/or titles or other indicators of media being selected via the input device 422. Display device 408 may be, for example, an LCD display device. In one embodiment, display device 408 and input device 422 may be integrated together in the same device (e.g., a touch screen LCD such as a multi-touch input panel which is integrated with a display device, such as an LCD display device). The display device 408 may include a backlight 410 to illuminate the display device 408 under certain circumstances. Device 408 and/or backlight 410 may be operated as described in co-pending U.S. patent application Ser. No. 11/650,014, filed Jan. 5, 2007, which is entitled “Backlight and Ambient Light Sensor System” and which is owned by the assignee of the instant inventions. This application is incorporated herein by reference in its entirety. It will be appreciated that the wireless device 400 may include multiple displays.

Wireless device 400 may also include a battery 418 to supply operating power to components of the system including digital RF transceivers 404, digital processing system 402, storage device 414, input device 422, microphone 420, audio transducer 416, media processing system 426, and display device 408. Battery 418 may be, for example, a rechargeable or non-rechargeable lithium or nickel metal hydride battery.

Wireless device 400 may also include one or more sensors 424 coupled to the digital processing system 402. The sensor(s) 424 may include, for example, one or more of a proximity sensor, accelerometer, touch input panel, ambient light sensor, ambient noise sensor, temperature sensor, gyroscope, a hinge detector, a position determination device, an orientation determination device, a motion sensor, a sound sensor, a radio frequency electromagnetic wave sensor, and other types of sensors and combinations thereof. Based on the data acquired by the sensor(s) 424, various responses may be performed (automatically in some cases) by the digital processing system to capture an image using camera 412, as described in further detail below. In some embodiments, sensors, displays, transceivers, digital processing systems, processor, processing logic, memories and/or storage device may include one or more integrated circuits disposed on one or more printed circuit boards (PCB).

FIG. 5 shows a block-diagram of one embodiment a device 500 to capture an image of an object. As shown in FIG. 5, device 500 has a processor 502, for example, a microprocessor, coupled to a camera 501. As shown in FIG. 5, one or more ambient light sensors (“ALSs”) 504 are coupled to processor 502. As shown in FIG. 5, camera 501 includes an image sensor 506 coupled to a camera optics 508. As shown in FIG. 5, processor 502 is coupled to an image sensor 506 of camera 501. The light from an object (not shown), which is passed through camera optics 508, strikes onto image sensor 506, as shown in FIG. 5. Image sensor 506 may be, for example, a charge coupled device (“CCD”), a complementary metal oxide semiconductor (“CMOS”), or any combination thereof. As shown in FIG. 5, image sensor 506 is coupled to processor 502 to process the captured image information. As shown in FIG. 5, processor 502 is coupled to one or more ambient light sensors 504 that are located outside camera 501.

In one embodiment, the one or more ALSs 504 are used to evaluate lighting conditions of the environment of the device 500 while the image is captured by image sensor 506, as described herein. In one embodiment, one or more ambient light sensors 504 evaluate the lighting conditions independently from image sensor 506. In one embodiment, one or more ambient light sensors 504 detect and measure the intensity, brightness, amplitude, and/or level of ambient light that surrounds device 500.

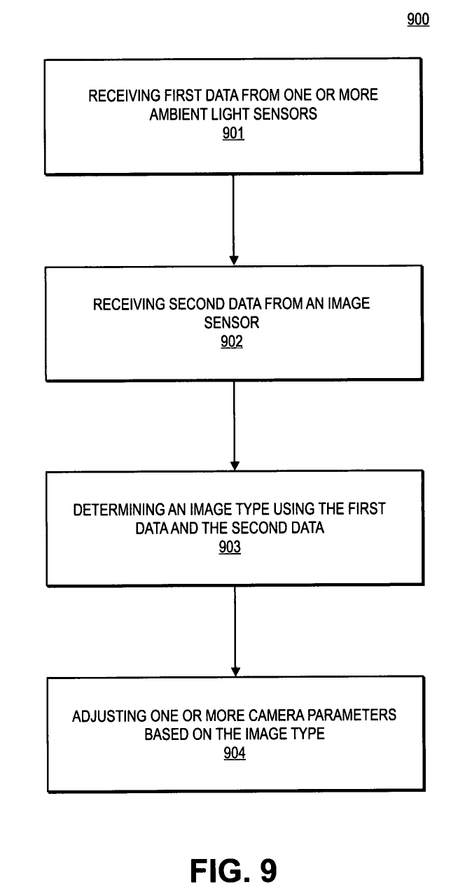

Processor 502 is configured to obtain light data using the ambient light sensor, and to determine an image type based on at least these light data, as described below. Processor 502 is further configured to adjust one or more parameters of camera 501 based on the image type, as described below. In one embodiment, processor 502 is further configured to receive light data from image sensor 506, as described below. FIG. 8 is a flowchart of one embodiment of a method 800 to capture an image using a camera. Referring to FIGS. 8 and 5, method 800 begins with operation 801 that involves obtaining light data using an ambient light sensor, such as sensor 504. In one embodiment, the light data include information about lighting conditions surrounding device 500. In one embodiment, the light data are obtained by measuring an ambient light intensity or brightness using one or more ALSs 504. Method continues with operation 802 that involves automatically determining an image type based on at least the first light data. The different image types may correspond to different lighting conditions, and may include, for example, an indoor image, outdoor image, office image, home image, incandescent light image, sunlight image, fluorescent light image.

In one embodiment, determining the image type includes determining lighting conditions of the environment that surrounds the device 500 to capture the image. For example, to capture a close macro image of an object, camera optics 508 may be substantially capped, and/or have substantially short distance to the object. In such a case the intensity of the light being captured by image sensor 506 may be substantially low. In such a case the real lighting conditions surrounding device to capture the image may not be determined properly using the information provided by the image sensor. The real lighting conditions can be determined by measuring the ambient light intensity using one or more ALSs 504 that are located outside the camera. In one embodiment, the ALS has a dynamic range between from 0 to 255 units, where the ambient light intensity sensed by the ALS around 0 units corresponds to substantially low or zero light intensity and the ambient light intensity around 255 units corresponds to substantially high light intensity.

In one embodiment, an indoor image type is determined if the intensity of the light measured by ALS 504 is between about 0 units to about 190 units. In one embodiment, the indoor image type is determined to apply an indoor profile to settings of the device 500 to capture the image. In one embodiment, an outdoor image type may be determined if the intensity of the light (e.g., light brightness) measured by ALS 504 is between about 190 units and about 256 units. In another embodiment, the outdoor image type may be determined if the ambient light brightness is about 100 times higher than the ambient light brightness for the indoor image type. In one embodiment, the outdoor image type is determined to apply an outdoor profile to settings of the device 500 to capture the image. That is, instead of determining the image type by the user, one or more ALSs are used to automatically determine the image type. Next, at operation 803, adjusting of one or more camera parameters based on the image type is performed. In one embodiment, the one or more camera parameters are adjusted based on the image type while the data from the one or more ALS's are received. The one or more camera parameters may be, for example, an exposure time, an exposure level, a shutter speed, a focal length, a white balance, a color profile, a color temperature, or any combination thereof. For a digital camera, the exposure level and the exposure time typically determine how long the sensor captures the light and how much the light is then amplified. The light can be amplified using an analog gain, digital gain, or a combination thereof. For example, the exposure level parameter setting may be reduced for an outdoor image type, and increased for an indoor image type. For example, a color temperature parameter setting may be increased for the outdoor image type, and decreased for the indoor image type.

In photography and image processing, white balance (sometimes gray balance, neutral balance, or color balance) typically refers to the adjustment of the relative amounts of red, green, and blue primary colors in an image such that colors are reproduced correctly on the image. Color balance changes the overall mixture of colors in an image and is used for generalized color correction. In one embodiment, the white balance setting of the camera is adjusted according to the image type that is determined based on the ambient light data from one or more ALSs. Generally, color temperature is a characteristic of visible light that is determined by comparing hue of a light source with a theoretical, heated black-body radiator. The Kelvin temperature at which the heated black-body radiator matches the hue of the light source is that source's color temperature.

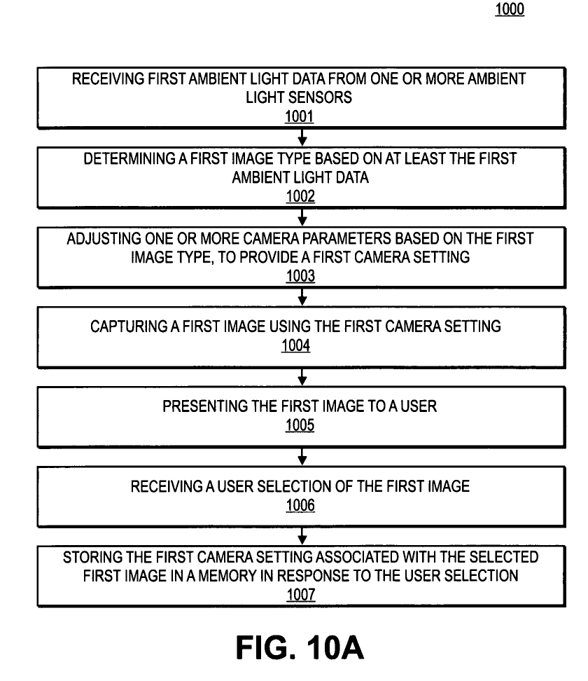

FIG. 9 is a flowchart of one embodiment of a method 900 to improve image capturing. Method 900 begins with operation 901 that involves receiving first data from one or more ambient light sensors, e.g., ALSs 504 of FIG. 5. In one embodiment, the first data include an ambient light intensity. Method continues with operation 902 that involves receiving second data from an image sensor, such as image sensor 506 of FIG. 5. In one embodiment, the second data from the image sensor are associated with an object, and the first data from the one or more ALSs are associated with an environment outside the object; e.g., the environment of the device to capture an image. In one embodiment, the second data is an intensity of the light that is reflected from the object whose image is captured, and the first data is an intensity of the light that surrounds the image capturing device. Next, operation 903 is performed that includes determining an image type using the first data and the second data. In one embodiment, the determining of the image type using a combination of the ALS data and the image sensor data includes determining split lighting conditions to capturing the image. The split lighting conditions can occur, for example, when the environment of the camera has one lighting conditions, and the environment of the object whose image is captured has another lighting conditions. For example, the split lighting conditions can occur when the camera is located in shade or indoors that has low ambient light brightness, and the subject being photographed is in bright sun or outdoors that has high ambient light brightness.

In another example, an object whose image is captured may be located in a room near a window. In such a case, the intensity of the light from the object that is captured by the image sensor may be substantially high. Based only on the information provided by the image sensor, the image type may be mistakenly determined to be an outdoor image type. To correct this, an ambient light is measured by one or more ALS sensors, and the ALS sensor data are used in combination with the image sensor data to determine split lighting conditions and a corresponding image type. That is, the combination of the ALS data and image sensor data are used to determine the type of the image.

Next, at operation 904 the one or more camera parameters are automatically adjusted based on the image type. For example, parameter settings of the camera; e.g., an exposure time, an exposure level, a shutter speed, a focal length, a white balance, a color profile, a color temperature, or any combination thereof, may be automatically adjusted according to the determined image type, to capture the image of improved quality. In one embodiment, one or more camera parameters, for example, a shutter speed, and/or light balance, are automatically set to a first value based on the information provided by the image sensor, and then the one or more camera parameters, for example, a shutter speed, and/or light balance are automatically re-adjusted to a second value, based on the ambient light data from the ALS. In one embodiment, the parameter settings of the camera are automatically adjusted while the ALSs data and the image sensor data are received.

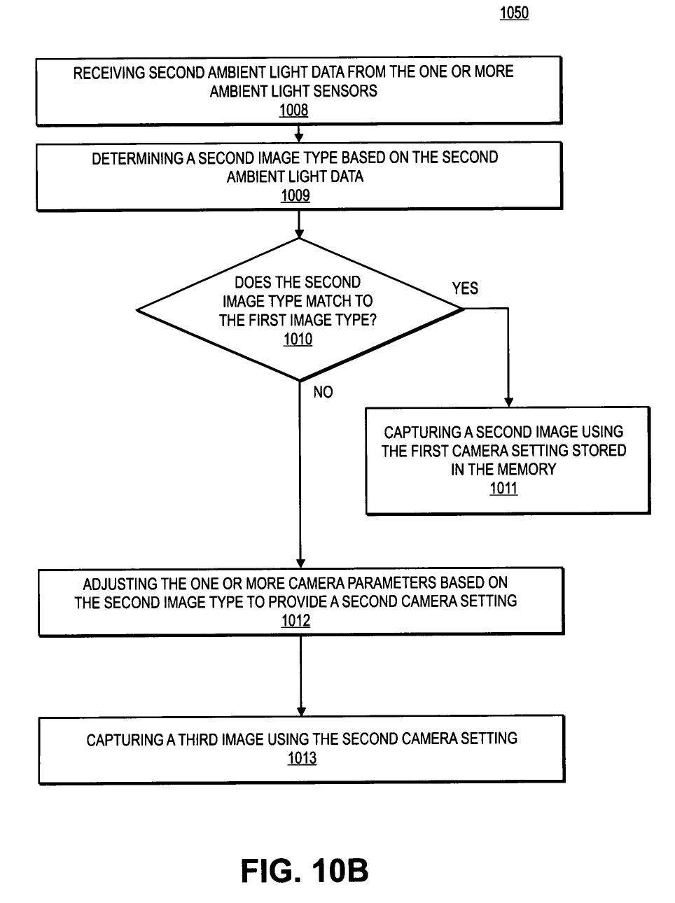

FIGS. 10A and 10B show a flowchart of one embodiment of a method 1000 to capture an improved image using a camera. Method 1000 begins with operation 1001 that involves receiving first ambient light data from one or more ambient light sensors, as described above. Method continues with operation 1002 that involves automatically determining a first image type based on at least the first ambient light data, as described above. For example, the first image type may be an office image. Next, operation 1003 that involves automatically adjusting one or more camera parameters based on the first image type, is performed. The one or more camera parameters are adjusted to provide a first camera setting. For example, the first camera setting may include the setting of a first exposure time, a first exposure level, a first shutter speed, a first focal length, a first white balance, a first color profile, a first color temperature, or any combination thereof.

A first image is captured using the first camera setting at operation 1004. Next, the first image is presented to a user at operation 1005. For example, the captured first image may be displayed to the user using a display device. Next, at operation 1006, a user selection of the first image is received. At operation 1007, in response to the user selection, storing of the first camera setting associated with the selected first image in a memory is performed. That is, the image can be presented to the user, so that the user can select the image as, for example, a user preference. The settings of the camera that are used to capture the selected image can be stored in the memory for the future use. Next, method 1000 continues at operation 1008 that involves receiving second ambient light data from the one or more ambient light sensors. At operation 1009 determining of a second image type based on the second ambient light data is performed.

Next, at operation 1010 determination is made whether the second image type matches the first image type. If the second image type matches the first image type, then a second image is captured at operation 1011 using the first camera setting stored in the memory. For example, if the first image type is the office image and the second image type is the office image, then the second image is captured using the first setting of the camera that may include a first exposure time, a first exposure level, a first shutter speed, a first focal length, a first white balance, a first color profile, a first color temperature, or any combination thereof. If the second image type does not match the first image type, then the one or more camera parameters are automatically adjusted at operation 1012 based on the second image type to provide a second camera setting. The second camera setting may include the setting of a second exposure time, a second exposure level, a second shutter speed, a second focal length, a second white balance, a second color profile, a second color temperature, or any combination thereof. For example, if the second image type determined based on the second ambient data is outdoor image, and the first image type is office image, then the one or more camera parameters are automatically adjusted to provide the second camera setting according to the outdoor image type. Next, operation 1013 is performed that involves capturing a third image using the second camera setting.

In one embodiment, the second image type is determined based on the stored first camera setting. That is, the image capturing device can adapt to the user preferences by learning the settings of the camera stored in the memory that are associated with the user preferences, and determining of the image type based on these user preferences.

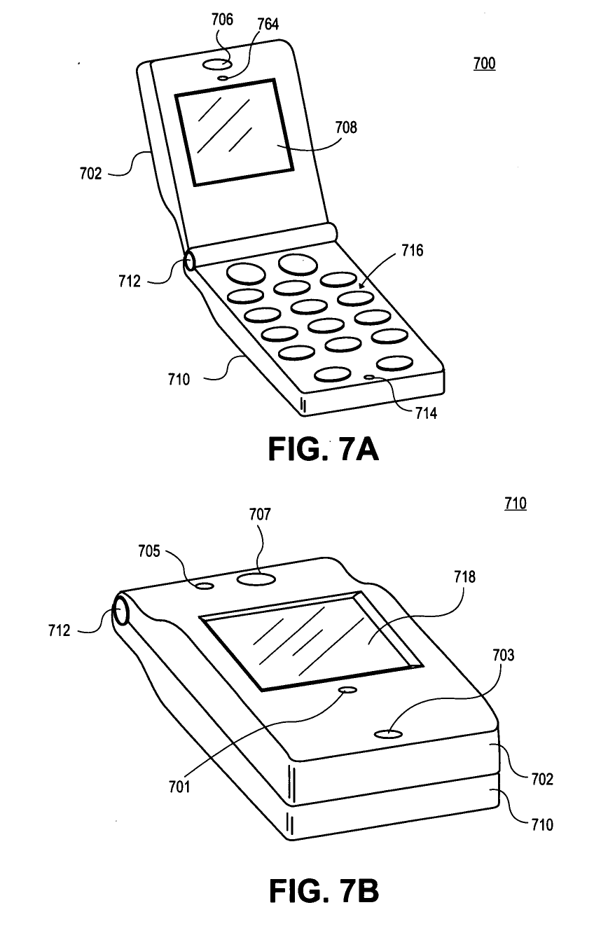

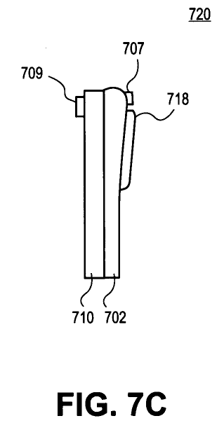

FIG. 6A illustrates a portable device 600 according to one embodiment of the invention. FIG. 6A shows a wireless device in a telephone configuration having a “candy-bar” style. In FIG. 6A, the wireless device 600 may include various features such as a housing 602, a display device 610, an input device 608 which may be an alphanumeric keypad, a speaker 620, a microphone 606 and an antenna 618. The wireless device 600 also may include one or more ambient light sensors (ALSs), such as ALS 614, 612, and 604, and/or proximity sensor (not shown) and an accelerometer (not shown). As shown in FIG. 6A, ALS 614 is positioned next to camera 616, ALS 604 is positioned near microphone 606, and ALS is positioned on the side of the housing 602 opposite to the side of camera 616. As shown in FIG. 6A, each of the one or more ALSs are positioned outside the optics of camera 616. Each of the ALSs can be used to provide ambient light information of environment of device 600 to capture an image, as described herein.

The proximity sensor may detect location (e.g., at least one of X, Y, Z), direction of motion, speed, etc. of objects relative to the wireless device 600. It will be appreciated that the embodiment of FIG. 6A may use more or fewer sensors and may have a different form factor from the form factor shown in FIG. 6A. It will also be appreciated that the particular locations of the above-described features may vary in alternative embodiments.

The display device 610 may be, for example, a liquid crystal display (LCD) which does not include the ability to accept inputs or a touch input screen which also includes an LCD. Device 610 may include a backlight and may be operated as described in co-pending U.S. patent application Ser. No. 11/650,014, filed Jan. 5, 2007, which is incorporated herein by reference in its entirety. The input device 608 may include, for example, buttons, switches, dials, sliders, keys or keypad, navigation pad, touch pad, touch screen, and the like.

In addition, a processing device (not shown) is coupled to the one or more ALSs 614. The processing device may be used to determine the location of objects and/or an ambient light environment relative to the portable device 600, the ALS and/or or proximity sensor based on the ambient light, location and/or movement data provided by the ALS and/or proximity sensor. The ALS and/or proximity sensor may continuously or periodically monitor the ambient light and/or object location. The proximity sensor may also be able to determine the type of object it is detecting. The ALSs described herein may be able to detect in intensity, brightness, amplitude, or level of ambient light and/or ambient visible light, incident upon the ALS and/or display device.

FIG. 6B shows a side view 610 of one embodiment of a portable device 600. As shown in FIG. 6B ALS 612 is located at one side of the portable device 600, and the optics of camera 616 is located at another side of portable device 600. As shown in FIG. 6B, ALS 612 senses the light in the direction that is different from the direction of the light sensed by camera 616.

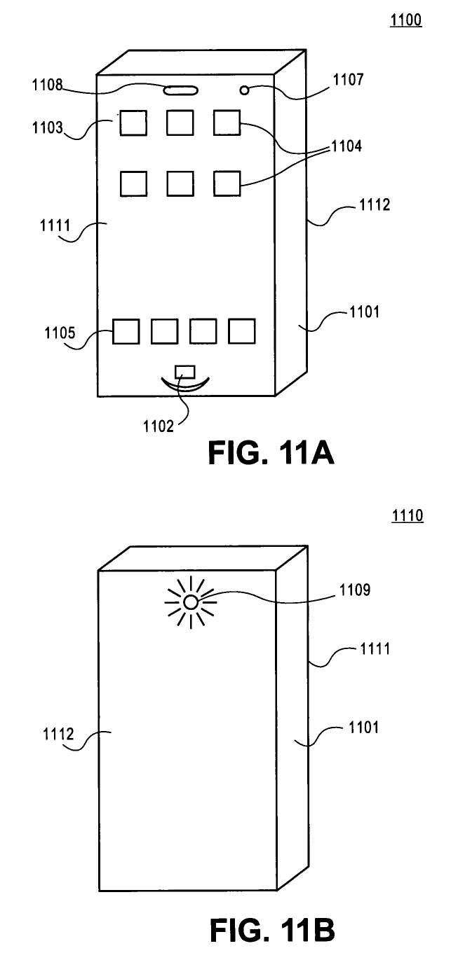

FIGS. 11A-11B illustrate a front view 1100 and a back view 1110 of a portable device 1101 to provide an improved image capture according to one embodiment of the invention. As shown in FIG. 11A, the wireless device 1101 may include a multi-touch display 1103 with controls 1105 and 1104. Controls 1105 may include, for example, a mobile phone control, mail control, web browsing control, iPod™ control, and the like. Controls 1104 may include, for example, a Short Message Service (“SMS”) option, calendar option, photos, camera, calculator, and the like. The device 1101 may include a speaker 1108, a microphone 1102, and an antenna (not shown). The wireless device 1100 also may include one or more ambient light sensors (ALSs), such as ALS 1107, and/or proximity sensor (not shown) and an accelerometer (not shown), and a camera 1109 (shown in FIG. 11B). As shown in FIG. 11, ALS 1107 is positioned on side 1111 of device 1101, and camera 1109 is positioned on opposite side 1112 of device 1101. As shown in FIG. 11, ALS 1107 is positioned outside the optics of camera 1109. ALS 1107 can be used to provide ambient light information of environment of device 1100 to capture an image, as described herein.

The proximity sensor may detect location (e.g., at least one of X, Y, Z), direction of motion, speed, etc. of objects relative to the wireless device 1100. It will be appreciated that the embodiment of FIG. 11 may use more or fewer sensors and may have a different form factor from the form factor shown in FIG. 11. It will also be appreciated that the particular locations of the above-described features may vary in alternative embodiments.

Device 1100 may include a backlight and may be operated as described in co-pending U.S. patent application Ser. No. 11/650,014, filed Jan. 5, 2007, which is incorporated herein by reference in its entirety. As shown in FIGS. 11A and 11B, ALS 1107 senses the light in the direction that is different from the direction of the light sensed by camera 1109. In one embodiment, device 1100 is an iPhone™ produced by Apple, Inc.

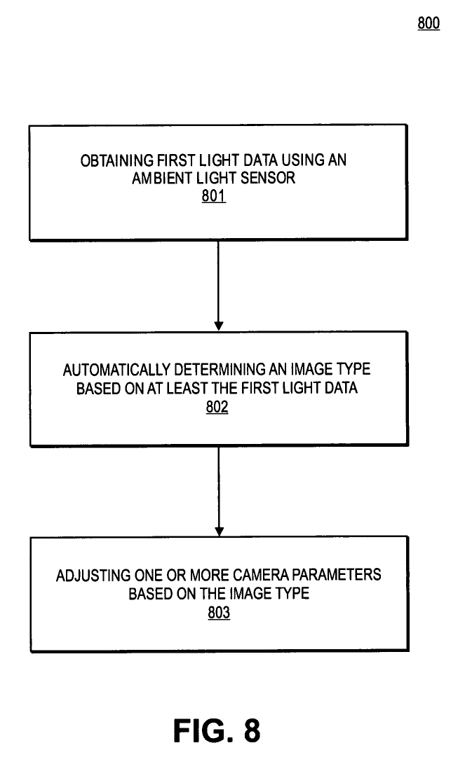

FIGS. 7A, 7B, and 7C illustrate a portable device 700 according to one embodiment of the invention. The portable device 700 may be a cellular telephone, which includes a hinge 712 that couples a display housing 702 to a keypad housing 710. The hinge 712 allows a user to open and close the cellular telephone so that it can be placed in at least one of two different configurations shown in FIGS. 7A and 7B. In one particular embodiment, the hinge 712 may rotatably couple the display housing to the keypad housing. In particular, a user can open the cellular telephone to place it in the open configuration shown in FIG. 7A and can close the cellular telephone to place it in the closed configuration shown in FIG. 7B. The keypad housing 710 may include a keypad 716 which receives inputs (e.g., telephone number inputs or other alphanumeric inputs) from a user and a microphone 714 which receives voice input from the user.

The display housing 702 may include, on its interior surface, a display 708 (e.g., an LCD), a speaker 764 and one or more ALSs, such as ALS 706, and a proximity sensor (not shown). On its exterior surface, the display housing 702 may include a speaker 703, a temperature sensor (not shown), a display 718 (e.g. another LCD), one or more ambient light sensors, such as ALS 701, and a proximity sensor 705, and a camera 707. The ALSs 706 and 701 and may be used to detect an ambient light environment of portable device 700 to provide improved image capturing using camera 707, as described herein.

FIG. 7C shows a side view of one embodiment of a portable device 700. As shown in FIG. 7C, an ALS 709 is positioned on a side of keypad housing 710, and camera 707 is positioned at an exterior surface of display housing 702, so that ALS 709 senses the light in the direction that is different from the direction of camera 707, to provide an improved image capturing, as described herein.

In at least certain embodiments, the portable device 700 may contain components which provide one or more of the functions of a wireless communication device such as a cellular telephone, e.g., an iPhone®, a media player, an entertainment system, a PDA, or other types of devices described herein. In one implementation of an embodiment, the portable device 700 may be a cellular telephone integrated with a media player which plays MP3 files, such as MP3 music files.

It is also considered that devices described herein may have a form factor or configuration having a “candy-bar” style, a “flip -phone” style, a “sliding” form, and or a “swinging” form. A “sliding” form may describe where a keypad portion of a device slides away from another portion (e.g., the other portion including a display) of the device, such as by sliding along guides or rails on one of the portions. A “swinging” form may describe where a keypad portion of a device swings sideways away (as opposed to the “flip-phone” style swinging up and down) from another portion (e.g., the other portion including a display) of the device, such as by swinging on a hinge attaching the portions. Each of the devices shown in FIGS. 3, 4, 5, 6A-6B, and 7A-7C may be a wireless communication device, such as a cellular telephone, and may include a plurality of components which provide a capability for wireless communication.

In the foregoing specification, embodiments of the invention have been described with reference to specific exemplary embodiments thereof. It will be evident that various modifications may be made thereto without departing from the broader spirit and scope of the invention. The specification and drawings are, accordingly, to be regarded in an illustrative sense rather than a restrictive sense.

What is claimed is:

1. A machine-implemented method to improve image capturing, comprising:
obtaining first light data using an ambient light sensor; and
determining an image type based on at least the first light data.

2. The machine-implemented method of claim 1, wherein the ambient light sensor is located outside a camera.

3. The machine-implemented method of claim 1, further comprising adjusting one or more camera parameters based on the image type.

4. The machine-implemented-method of claim 1, wherein the determining the image type includes
determining lighting conditions to capture the image.

5. The machine-implemented method of claim 1, wherein the obtaining the first light data includes measuring an ambient light intensity.

6. The machine-implemented method of claim 1, further comprising
obtaining second light data using an image sensor.

7. A machine-implemented method to improve image capturing, comprising:
receiving first data from one or more ambient light sensors;
receiving second data from an image sensor; and
determining an image type using the first data and the second data.

8. The machine-implemented method of claim 7, wherein the one or more ambient light sensors are located outside a camera.

9. The machine-implemented method of claim 7, further comprising
adjusting one or more camera parameters based on the image type.

10. The machine-implemented method of claim 8, wherein the one or more camera parameters is an exposure time, an exposure level, a shutter speed, a focal length, a white balance, a color profile, or any combination thereof.

11. The machine-implemented method of claim 7, wherein the first data include an ambient light intensity.

12. The machine-implemented method of claim 7, wherein the determining the image type includes determining split lighting conditions for the image.

13. The machine-implemented method of claim 7, wherein the second data are associated with an object; and the first data are associated with an environment outside the object.

14. A machine-implemented method to capture an improved image using a camera, comprising:
receiving first ambient light data from one or more ambient light sensors;
determining a first image type based on at least the first ambient light data;
adjusting one or more camera parameters based on the first image type, to provide a first camera setting;
capturing a first image using the first camera setting;
presenting the first image to a user;
receiving a user selection of the first image; and
storing the first camera setting associated with the selected first image in a memory in response to the user selection.

15. The machine-implemented method of claim 14, further comprising receiving second ambient light data from the one or more ambient light sensors;
determining a second image type based on the second ambient light data;
determining whether the second image type matches the first image type; and
capturing a second image using the first camera setting stored in the memory if the second image type matches the first image type.

16. The machine-implemented method of claim 15, further comprising
adjusting the one or more camera parameters based on the second image type to provide a second camera setting if the second image type does not match the first image type; and
capturing a third image using the second camera setting.

17. The machine-implemented method of claim 15, wherein the second image type is further determined based on the stored first camera setting.

18. The machine-implemented method of claim 14, wherein the one or more ambient light sensors are located outside the camera.

19. The machine-implemented method of claim 14, wherein the one or more camera parameters is an exposure time, an exposure level, a shutter speed, a focal length, a white balance, a color profile, or any combination thereof.

20. A device, comprising:
a camera;
a processor coupled to the camera; and
an ambient light sensor coupled to the processor, wherein the processor is configured to obtain first light data using the ambient light sensor, and to determine an image type based on at least the first light data.

21. The device of claim 20, wherein the processor is further configured to adjust one or more camera parameters based on the image type.

22. The device of claim 20, wherein the camera has an image sensor; and the processor is further configured to receive second light data from the image sensor.

23. The device of claim 20, further comprising a cell phone coupled to the processor.

24. The device of claim 20, wherein the device is portable.

25. A device, comprising:
a camera having an image sensor;
a processor coupled to the camera; and
one or more ambient light sensors coupled to the processor, wherein the processor is configured to receive second data from the image sensor; receive first data from the one or more ambient light sensors; and to determine an image type using the first data and the second data.

26. The device of claim 25, wherein the processor is further configured to adjust one or more camera parameters based on the image type.

27. A device, comprising:
a camera;
a processor coupled to the camera;
one or more ambient light sensors coupled to the processor;
a display coupled to the processor; and
a memory coupled to the processor, wherein the processor is configured to receive first ambient light data from the one or more ambient light sensors; to determine a first image type based on at least the first ambient light data; to adjust one or more camera parameters based on the first image type to provide a first camera setting; to capture a first image using the first camera setting; to present the first image to a user on the display; to receive a user selection of the first image; and to store the first camera setting associated with the selected first image in a memory in response to the user selection.

28. The device of claim 27, wherein the processor is further configured to
receive second ambient light data from the one or more ambient light sensors; to determine a second image type based on the second ambient light data; to determine whether the second image type matches the first image type; and to capture a second image using the first camera setting stored in the memory if the second image type matches the first image type.

29. The device of claim 28, wherein the processor is further configured to
adjust the one or more camera parameters based on the second image type to provide a second camera setting if the second image type does not match the first image type; and to
capture a third image using the second camera setting.

30. A machine readable medium containing executable program instructions which cause a data processing system to perform operations comprising:
obtaining first light data using an ambient light sensor; and
determining an image type based on at least the first light data.

31. The machine readable medium of claim 30, wherein the ambient light sensor is located outside a camera.

32. The machine readable medium of claim 30 further including data that cause the data processing system to perform operations comprising
adjusting one or more camera parameters based on the image type.

33. The machine readable medium of claim 30, wherein the obtaining the first light data includes measuring an ambient light intensity.

34. The machine readable medium of claim 30 further including data that cause the data processing system to perform operations comprising
obtaining second light data using an image sensor.

35. A machine readable medium containing executable program instructions which cause a data processing system to perform operations comprising
receiving second data from an image sensor;
receiving first data from one or more ambient light sensors;
determining an image type using the first data and the second data.

36. The machine readable medium of claim 35, wherein the one or more ambient light sensors are located outside optics of a camera.

37. The machine readable medium of claim 35 further including data that cause the data processing system to perform operations comprising
adjusting one or more camera parameters based on the image type.

38. The machine readable medium of claim 35, wherein the second data are associated with an object, and the first data are associated with an environment outside the object.

39. A machine readable medium containing executable program instructions which cause a data processing system to perform operations comprising
receiving first ambient light data from one or more ambient light sensors;
determining a first image type based on at least the first ambient light data;
adjusting one or more camera parameters based on the first image type, to provide a first camera setting;
capturing a first image using the first camera setting;
presenting the first image to a user;
receiving a user selection of the first image; and
storing the first camera setting associated with the selected first image in a memory in response to the user selection.

40. The machine readable medium of claim 39 further including data that cause the data processing system to perform operations comprising
receiving second ambient light data from the one or more ambient light sensors;
determining a second image type based on the second ambient light data;
determining whether the second image type matches the first image type; and
capturing a second image using the first camera setting stored in the memory if the second image type matches the first image type.

41. The machine readable medium of claim 39 further including data that cause the data processing system to perform operations comprising
adjusting the one or more camera parameters based on the second image type to provide a second camera setting if the second image type does not match the first image type; and
capturing a third image using the second camera setting.

42. The machine readable medium of claim 39, wherein the one or more ambient light sensors are located outside a camera optics.

43. A data processing system, comprising:
means for obtaining first light data using an ambient light sensor; and
means for determining an image type based on at least the first light data.

44. A data processing system, comprising:
means for receiving second data from an image sensor;
means for receiving first data from one or more ambient light sensors; and
means for determining an image type using the first data and the second data.

45. A data processing system, comprising:
means for receiving first ambient light data from one or more ambient light sensors;
means for determining a first image type based on at least the first ambient light data;
means for adjusting one or more camera parameters based on the first image type, to provide a first camera setting;
means for capturing a first image using the first camera setting;
means for presenting the first image to a user;
means for receiving a user selection of the first image; and
means for storing the first camera setting associated with the selected first image in a memory in response to the user selection.
